(19) United States
(12) Patent Application Publication
(10) Pub. No.: US 2024/0123740 A1
(43) Pub. Date: Apr. 18, 2024

(54) SYSTEMS AND DEVICES FOR TRANSFERRING IMAGES TO ARTICLES AND METHODS OF MAKING THE SAME

(71) Applicant: Neenah Inc., Alpharetta, GA (US)

(72) Inventor: Abdu Bunch, Marquette, MI (US)

(21) Appl. No.: 18/481,314

(22) Filed: Oct. 5, 2023

Related U.S. Application Data
(60) Provisional application No. 63/417,294, filed on Oct. 18, 2022.

(51) Int. Cl. B41J 3/407; B41J 11/00; B41J 29/40

(52) U.S. Cl. CPC B41J 3/4078; B41J 11/002; B41J 29/40; B41J 2202/03

(57) ABSTRACT

Transfer assemblies and transfer sheets and release paper for transferring images to articles, such as textiles, fabric or the like, are provided. In addition, improved methods for manufacturing the transfer sheets and the articles are provided. A transfer sheet comprises a support layer and an image transfer layer that includes an ink receptor and a blocking agent. The blocking agent is configured to block or impede the transfer of the ink composition to the substrate in non-printed areas of the image and substantially allow the transfer of the ink composition to the substrate in printed areas of the image. The systems and methods described herein provide a single step process that is “self-weeding”, while minimizing defects in the image that is printed onto the article and are particularly useful for transferring white or colored images to dark colored or black textiles and other fabrics.

### CROSS-REFERENCE TO RELATED APPLICATIONS

This application claims the benefit of U.S. Provisional Application No. 63/417,294 filed on Oct. 18, 2022, the complete disclosure of which is incorporated herein by reference for all purposes.

### TECHNICAL FIELD

This description generally relates to transfer assemblies, transfer sheets and/or release papers for transferring messages, designs, pictures or other images to articles, such as textiles and other fabrics, and methods for manufacturing the transfer sheets and the articles.

### BACKGROUND

In recent years, a significant industry has developed which involves the application of customer-selected designs, words, numbers, messages, illustrations, and the like (referred to collectively hereinafter as “images”) on articles, such as T shirts, sweat shirts, leather goods, and the like. These images may be commercially available products tailored for a specific end-use and printed on a release or transfer paper, or the customer may generate the images on a heat transfer paper. The transfer sheet is brought in contact with the article to be printed, and heat and pressure are applied to the backing layer, causing the binder present in the image transfer layer to release from the backing layer and flow to the article, along with the printed image.

Typically, only a portion of the image transfer layer is printed with an image, and the remainder of the image transfer layer is blank. Nevertheless, heat and pressure applied to the backing layer causes the entire image transfer layer to flow and bind to the article. Consequently, the image printed on the article is surrounded by a field of binder, corresponding to the overall dimensions of the transfer sheet.

Various methods and transfer sheet assemblies have been proposed to limit transfer of the unimaged or non-printed areas of a transfer sheet, when printing an image on an article. Some papers have been developed that are “weedable”, that is, portions of the transferable coating can be removed from the heat transfer paper prior to the transfer to the substrate. Weeding involves cutting around the printed areas and removing the coating from the extraneous non-printed areas. However, such weeding processes can be difficult and time consuming to perform, especially around intricate graphic designs.

Two-sheet systems have been developed to transfer images onto substrates while limiting the transfer of non-printed areas to the article or substrate. These two-sheet “self-weeding” systems involve a printable carrier (component A) that comprises the image in the form of an at least partial area toner layer, and a component B that comprises a carrier and a polymer layer applied thereto. Unfortunately, these systems require two different sheets and the transfer process requires two steps under elevated temperature and pressure conditions, as well as an additional separation step of components A and B.

Another method of limiting the transfer of the non-printed areas of a transfer sheet to the article with a single sheet involves the use of a blocking agent within the transfer sheet. An aqueous ink composition incorporating a colorant is printed on the image transfer layer of the transfer assembly. The liquid carrier present in the ink composition penetrates the image transfer layer, causes disruption of the blocking agent and is absorbed by the ink receptor, but only in the printed areas. The blocking agent is not disrupted in the non-printed areas, i.e. the areas where the ink composition has not been absorbed. One such transfer sheet that includes a blocking agent is described in U.S. Pat. No. 9,399,362, the complete disclosure of which is incorporated herein by reference.

While these efforts have generally improved the process of transferring images to articles, they also suffer from a number of drawbacks. For example, the vividness and brilliance of the image colors and the wash resistance of the transferred image is generally not satisfactory, particularly with respect to dark colored and black substrates and fabrics. In addition, the transfer sheets and/or the printed image developed from these methods often exhibit “fisheyes” (i.e., circular voids, divots or separation), white streaks, spottiness and/or blistering, particularly when transferring white or colored images to darker textiles. These defects all contribute to a relatively poor rendering of the image.

It would therefore be desirable to provide improved systems and methods for transferring images to articles, such as fabrics or textiles. In particularly, it would be desirable to provide systems and methods that limit or completely eliminate the transfer of the non-printed areas, while minimizing any defects in the image that is printed onto the article.

### SUMMARY

The following presents a simplified summary of the claimed subject matter in order to provide a basic understanding of some aspects of the claimed subject matter. This summary is not an extensive overview of the claimed subject matter. It is intended to neither identify critical elements of the claimed subject matter nor delineate the scope of the claimed subject matter. Its sole purpose is to present some concepts of the claimed subject matter in a simplified form as a prelude to the more detailed description that is presented later.

Transfer assemblies and transfer sheets or release papers for transferring images to articles, such as textiles, fabric or the like, are provided. In addition, improved methods for manufacturing the transfer sheets and the articles are provided. The systems and methods described herein provide a single step process that is “self-weeding” and therefore less expensive and time consuming than conventional systems. In addition, these systems and methods minimize defects in the image printed on the article, while improving the article's vividness, shelf-life aging and washability. The transfer sheets described herein are particularly useful for transferring white or colored images to dark colored or black textiles, such as T-shirts, hats, sweatshirts and the like.

In one aspect, a transfer sheet for transferring an image onto a substrate is provided. The transfer sheet is produced by a process that includes providing a support layer and an image transfer layer that includes an ink receptor and a blocking agent that substantially impedes the transfer of non-printed areas of the image. The process further comprises contacting the support layer with the image transfer layer and applying heat and pressure to the image transfer layer such that the image transfer layer is heated to a temperature of less than about 180 degrees Fahrenheit.

Applicant has discovered that applying heat above 180 degrees Fahrenheit to the image transfer layer during this process may result in white streaks, spottiness, blistering or other defects, which all contribute to a relatively poor rendering of the image. These defects are particularly noticeable on darker or black textiles. Applicant has further discovered that these defects can be substantially minimized or eliminated with a lower temperature drying profile. In certain embodiments, the image transfer layer is heated to a temperature of about 120 degrees Fahrenheit to about 180 degrees Fahrenheit, preferably about 140 degrees Fahrenheit to about 150 degrees Fahrenheit.

In embodiments, the transfer sheet further includes a release layer between the support layer and the image transfer layer. The release layer may comprise any suitable material that allows for removably attaching the release layer to the support layer . The release coat can function as a hot, warm, or cold peel. . The release layer may be a partially fluid coating having a viscosity of about 25 CPS to about 90 CPS, preferably about 50 CPS to about 60 CPS.

In embodiments, the image transfer layer does not include a defoamer or foam control agent. Image transfer layers used in certain conventional transfer sheets contain defoamers or other foam control agents to reduce or eliminate foam that is formed during the production process. These defoamers, however, may cause fisheyes, white streaks, spottiness, blistering or other defects to appear in the article, particularly with darker textiles. Applicant has discovered that removing the defoamers from the image transfer layer minimizes or eliminates these defects. Reducing the viscosity of the release layer may also reduce the creation of foam during the production process, creating less defects in the image rendered on the article.

In embodiments, the image transfer layer has a solids content of less than about 60% by weight, or less than about 50% by weight, preferably the solids content is less than about 40% by weight. The viscosity of the image transfer layer may be about 50 CPS to about 200 CPS, preferably about 100 CPS to about 130 CPS.

In embodiments, the image transfer layer comprises a first layer or print coat comprising the ink receptor and the blocking agent and a second layer comprising a binder or tie coat. The binder preferably comprises materials that improve the adherence between the release layer and the image transfer layer. In certain embodiments, the second layer or binder has a viscosity of about 100 CPS to about 130 CPS. Suitable materials for the binder include a wax, a thermoplastic polymer or pre-polymer and combinations thereof. In an exemplary embodiment, the binder comprises a polyester or polyester blend that allows sublimation inks to be used in the ink composition. In certain embodiments, the binder material is hydrophobic and does not swell when in contact with water. The first and second layers may be mixed together or they may be formed as separately layers that are placed in contact with, or bonded to, each other.

In embodiments, the transfer sheet further comprises a third layer or white base coat between the print coat and the tie coat The third layer may comprise an opaque layer that includes one or more materials that increase an overall opacity of the image transfer layer, thereby improving the ability of the rendered image to “hide” what is behind the image. This allows a user to read or view the front side of the image without being distracted by print images on the back side. Suitable materials for the third layer include titanium dioxide and the like. In certain embodiments, the third layer or white base coat may have a viscosity of about 50 CPS to about 150 CPS. The third layer may be mixed with either or both of the first and second layers or they may be formed as separately layers that are placed in contact with, or bonded to, each other.

In embodiments, the ink composition comprises a colorant and an aqueous liquid carrier. The compositions are not limited to a particular type of colorant and include, organic and inorganic pigments, dyes, or macromolecular coloring agents, such as poly(oxyalkylene), substituted chromophores and polymers incorporating such compounds, such as polyurethanes and polyesters. By way of further example, the colorant may be selected from sublimation dyes, disperse dyes, reactive dyes, acid dyes, and basic dyes, as well as titanium dioxide, carbon black, and calcium carbonate.

The ink composition may be printed on the upper surface of the transfer sheet by any of a variety of conventional techniques. By way of example, the ink composition may be applied by inkjet printing, screen printing, lithographic printing, stamping, gravure printing or the ink composition may be applied by manually. In an exemplary embodiment, the ink composition is applied by inkjet printing.

The blocking agent is a hydrophilic component that is capable of forming a film that can be disrupted by water. The blocking agent is substantially disrupted by the liquid carrier in the printed areas and the blocking agent is substantially not disrupted by the liquid carrier in the non-printed areas. This allows the blocking agent to substantially block transfer of the ink composition to the substrate in the non-printed areas while substantially allowing transfer of the ink composition to the substrate in the printed areas. In embodiments, 50 weight % or less, or 40 weight % or less, in particular, 25 weight % or less, or even 15 weight % or less of the non-printed areas of the transfer assembly is transferred to the article during the transfer process. Suitable materials for the blocking agent include, but are not limited to, poly(vinyl alcohol), poly(ethylene glycol), poly(vinyl pyrrolidone), polyacrylic acid, polyacrylamides, N-(2-hydroxypropyl) methacrylamide, Xanthan gum, pectins, dextran, carrageenan, guar gum, cellulose ethers, hyaluronic acid, albumin, and starch and starch derivatives.

In an exemplary embodiment, the blocking agent comprises a starch or a starch derivative. In certain embodiments, the blocking agent comprises about 30% to about 40% by weight of the print coat, preferably about 36% by weight.

In embodiments, the ink receptor comprises a hydrophilic organic material that attaches to ink molecules. Suitable materials for the ink receptor include, but are not limited to, poly(acrylic acid), poly(vinyl imidazole), poly(2-hydroxyethyl methacrylate), poly(vinyl pyrrolidone), poly(Vinyl)poly(pyrrolidone), and polyvinyl acetate, cationic polymers and their salts, hygroscopic inorganic salts, silica and zeolites.

In certain embodiments, the binder, blocking agent and the ink receptor are mixed together in a single image transfer layer that is applied to the release layer. In other embodiments, the image transfer layer is separated into two strata or layers. The first layer comprises the binder and the ink receptors and the second layer comprises the blocking agent. The first layer is adhered to the release layer and the second layer is adhered to the first layer. In yet another embodiment, the image transfer layer comprises three strata or layers. The first layer that is applied to the release layer comprises the binder. The second layer that is applied to the binder comprises the ink receptor. The third layer that is applied to the ink receptor layer comprises the blocking agent.

The transfer sheet may be used to transfer an image onto an article by contacting the support layer to the article and applying heat and pressure to transfer the ink composition, thereby rendering the image onto the article. The substrate or article may comprise any suitable article in which it is desired to print an image. For example, the article may comprise a white, dark colored or black textile or other fabric. In certain embodiments, the article comprises a dark colored or black textile. The textile may comprise 100% cotton, less than 100% cotton or cotton/polyester blends.

In one embodiment, the temperature for transferring the ink composition to the article is between about 350 to about 400 degrees Fahrenheit, or from about 365 to about 374 degrees Fahrenheit. The pressure may be between about 40 to 75 psi or about 50 to 60 psi. The heat and pressure may be applied to the article and the transfer sheet for a time period of about 10 to 30 seconds, or about 15 to 20 seconds, or about 18 seconds.

In certain embodiments, the transfer sheet has been produced such that the coating composition is not fully “cured” on the article after the heating and/or drying steps. In other words, the “degree of cure” of the ink composition in the article is less than 100%, preferably about 30% to about 80%, or about 40% to about 60%. Partially curing the coating composition with heat and pressure reduces defects in the printed image, thereby improving its appearance.

The “degree of cure” is defined herein to mean the degree in which the composition has cross-linked sufficiently so that it is substantially in its final form (i.e., no further cross-linking and/or no further substantial changes will occur to the composition). The degree of cure as defined here does not necessarily mean that the composition is 100% cross-linked such it has become a fully cured resin, but rather 100% of the curing that will occur before the composition does not substantially change in function or appearance.

In certain embodiments, the article is aged over a period of time to increase the degree of cure of the ink composition, thereby increasing the vibrancy of the printed image. For example, the article may be aged for a time period of about 2 days to about 6 months, or about 1 week to about 3 months or about 1-2 months, which results in an increase in the “degree of cure” (as defined above) by about 20% to about 80%, or about 40% to about 60%. Applicant has discovered that allowing the coating composition to complete the cure process through aging (rather than immediately with heating and drying) reduces defects caused by the drying process, while still ultimately resulting in a vivid and brilliant image in the article.

In another aspect, a transfer sheet for transferring an image onto a substrate comprises a support layer and an image transfer layer overlying the support layer. The image transfer layer comprises an ink receptor and a blocking agent. The ink receptor is configured to receive an ink composition so as to define printed areas and non-printed areas in the image transfer layer. The transfer sheet further includes a release layer between the support layer and the image transfer layer. The release layer may be a partially fluid coating having a viscosity of about 25 CPS to about 90 CPS, preferably about 50 CPS to about 60 CPS. Reducing the viscosity of the release layer may also reduce the creation of foam during the transfer process, creating less defects in the image rendered on the article.

The release layer may comprise any suitable material that allows for removably attaching the release layer to the support layer. The release coat can function as a hot, warm or cold peel.

In embodiments, the image transfer layer has a solids content of less than about 60% by weight, or less than about 50% by weight, preferably the solids content is less than about 40% by weight. The viscosity of the image transfer layer may be about 50 CPS to about 200 CPS, preferably about 100 CPS to about 130 CPS. This reduces the amount of foam created during the production process without the presence of a defoamer, thereby minimizing the creation of defects and dramatically improving the image rendered onto the article.

In another aspect, a method for manufacturing a transfer sheet comprises providing a support layer and an image transfer layer in contact with the support layer. The image transfer layer comprises an ink receptor and a blocking agent. The method further comprises contacting the support layer with the image transfer layer and applying heat and pressure to the image transfer layer such that the image transfer layer is heated to a temperature of less than about 180 degrees Fahrenheit during production

In certain embodiments, the transfer sheet is heated to a temperature of about 120 degrees Fahrenheit to about 180 degrees Fahrenheit, preferably about 140 degrees Fahrenheit to about 150 degrees Fahrenheit during production

The method further comprises printing an ink composition onto a surface of the image transfer layer thereby defining printed areas and non-printed areas, such that the blocking agent substantially impedes transfer of the ink composition to the article in the non-printed areas and substantially allows transfer of the ink composition to the article in the printed areas. The transfer sheet may then be used to transfer the image onto an article by contacting the support layer to the article and applying heat and pressure to transfer the ink composition rendering the image to the article. The transfer sheet is then separated from the article.

In certain embodiments, the heat and pressure is applied to the transfer sheet such that the coating composition is not fully cured on the article after the heating and drying steps. In an exemplary embodiment, the heat and pressure may be applied for a time period of 15 to 20 seconds.

In certain embodiments, the article is aged over a period of time to increase the degree of cure of the coating composition, thereby increasing the vibrancy of the printed image. For example, the article may be aged for a time period of about 2 days to about 6 months, or about 1 week to about 3 months or about 1-2 months

In embodiments, the image transfer layer is a partially fluid coating having a viscosity of about 50 CPS to about 200 CPS, preferably about 100 CPS to about 130 CPS.

In embodiments, the transfer sheet further includes a release layer between the support layer and the image transfer layer. The release layer may comprise any suitable material that allows for removably attaching the release layer to the support layer . Suitable materials for the release layer include hot peels, cold peel, hot split and the like. The viscosity of the release layer is about 25 CPS to about 90 CPS, preferably about 50 CPS to about 60 CPS.

The recitation herein of desirable objects which are met by various embodiments of the present description is not meant to imply or suggest that any or all of these objects are present as essential features, either individually or collectively, in the most general embodiment of the present description or any of its more specific embodiments.

### BRIEF DESCRIPTION OF THE DRAWINGS

FIG. 1 illustrates a transfer sheet for transferring an image onto a substrate or article;

FIG. 2 shows another embodiment of a transfer sheet for transferring an image onto a substrate or article;

FIG. 3 shows another embodiment of a transfer sheet for transferring an image onto a substrate or article;

FIG. 4 is a photograph of an image after a first pass coating with a conventional prior art release coat layer;

FIG. 5 is a photograph of the image in FIG. 4 after a second pass coating with a conventional prior art image transfer layer;

FIG. 6 is a photograph of an image after first and second pass coatings with an image transfer layer described herein;

FIG. 7 is a photograph of an image after a first pass coating with an image transfer layer described herein at a lower drying profile;

FIG. 8 is a photograph of the image of FIG. 7 after a second pass coating with an image transfer layer described herein at a lower drying profile;

FIG. 9 is a photograph of an image after a first pass coating with an image transfer layer described herein at a lower drying profile;

FIG. 10 illustrates a T-shirt having an image transferred thereon with the systems and methods described herein, before the image has been aged; and

FIG. 11 illustrates the T-shirt of FIG. 10 after accelerated aging.

### DETAILED DESCRIPTION OF THE EMBODIMENTS

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

Systems and methods for transferring images to articles, such as textiles, fabric or the like, are provided. In addition, improved methods for manufacturing transfer assemblies and sheets are provided. The systems and methods provided herein are a single step, “self-weeding”, process that minimizes transfer of the non-printed areas to the article, while reducing or eliminating defects in the image that is printed onto the article.

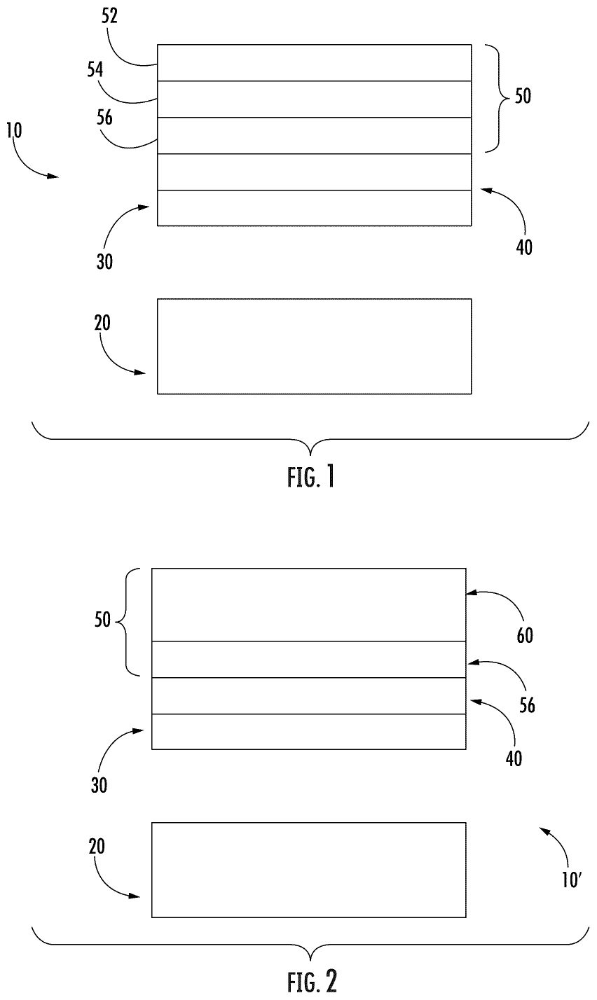

FIG. 1 illustrates one embodiment of a transfer sheet 10 for transferring an image to an article 20. Transfer sheet 10 comprises a support layer or base sheet 30, a release layer 40 and an image transfer layer 50 that includes at least a binder, an ink receptor and a blocking agent. An ink composition or printed coating containing the image is applied to the upper surface of image transfer layer 50. The ink composition may include printed areas and nonprinted areas. As discussed in detail below, heat and pressure are applied to transfer sheet 10 to transfer the ink composition or printed coating from image transfer sheet 50 to base sheet 30 and then to article 20.

The ink composition may be printed on the upper surface of the transfer sheet by any of a variety of conventional techniques. By way of example, the ink composition may be applied by inkjet printing, screen printing, lithographic printing, stamping, gravure printing or the ink composition may be applied by manually. The formulation of the ink composition may be adjusted to be compatible with the printing method selected. The ink composition may range in consistency from a liquid to a paste.

The ink composition may contain additional components, as known to those skilled in the art, such as binders, humectants, surfactants and the like. The aqueous carrier liquid may, in addition to water, incorporate minor amounts of organic co-solvents that are water miscible, such as lower alcohols, glycols and glycerin. By way of example, the organic co-solvents may comprise 20 weight % or less of the liquid carrier component of the ink composition.

In an exemplary embodiment, the ink composition is a sublimation ink applied by inkjet printing in a one-step process.

The substrate or article may comprise any suitable article in which it is desired to print an image. Suitable articles include T-shirts-, sweatshirts, hats, leather goods, signs, laminates, metal, glass, wood, paper or other cellulosic material and the like. The article may be a woven, knitted or non-woven textile material consisting of natural or synthetic fibers, or combinations thereof. By way of example, the textile may comprise fibers selected from cotton, wool, jute, hemp, polyester, polyamide, polyurethane and polyolefin.

The article may comprise a white textile, dark colored textile or a black textile. In certain embodiments, the article comprises a dark colored or black textile. The textile may comprise 100% cotton, less than 100% cotton or cotton/polyester blends.

In this embodiment, image transfer layer 50 comprises three layers: (1) a print coat layer 52 that includes the ink receptor and the blocking agent; (2) a white base coat or opaque layer 54; and (3) a tie coat layer 56 that contains the binder. The three layers may be formed separately and applied to each other such that tie coat layer 56 is disposed between the other two layers and release layer 40. Alternatively, one or more of the layers may be mixed together.

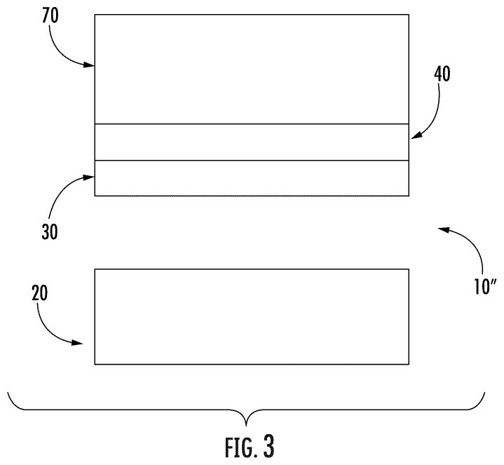

FIG. 2 illustrates an alternative embodiment of a transfer sheet 10′ wherein the print coat layer and the white base coat layer are mixed together to form a single layer 60 and applied to tie coat layer 56. FIG. 3 illustrate yet another embodiment of a transfer sheet 10″ wherein all three of these layers are mixed together to form a single layer 70 and applied to release layer 40. In yet another embodiment, the blocking agent and the ink receptors may be formed in separate layers. These separate layers may, or may not, include the binder or the opaque layer.

Image transfer layer 50 notably does not comprise a defoamer or any other foam control agent. In embodiments, the image transfer layer has a solids content of less than about 60% by weight, or less than about 50% by weight, preferably the solids content is less than about 40% by weight. The viscosity of the image transfer layer 50 prior to heating and drying is about 25 Centipoise (CPS) to about 200 CPS. In embodiments, the image transfer layer has a viscosity of about 50 CPS to about 200 CPS, preferably about 100 CPS to about 130 CPS.

Release layer 40 allows image transfer layer 50 to be separated from base sheet 30 after the print coating has been applied to article 20. Release layer 40 may comprise any suitable material that allows for removably attaching release layer 40 to base sheet 30. Suitable materials for release layer 40 include hot peels, cold peel, hot split and the like.

In an exemplary embodiment, release layer 40 is a hot peel comprising an ethylene acrylic acid copolymer (EAA) in an aqueous dispersion. The EAA may be present in at least about 50% of the base sheet, at least about 75% of the base sheet or at least about 90% of the base sheet. In certain embodiments, the base sheet may further include a surfactant and/or a polyester dispersion. In one exemplary embodiment, the base sheet comprises about 94% EAA dispersion, about 2% surfactant and about 4% polyester dispersion. The EAA dispersion may, for example, comprise Michem® Prime 74994, manufactured by Michelman, Inc. of Cincinnati, Ohio. The surfactant may, for example, comprise a silicone surfactant, such as BYK®-348, manufactured by BYK. The polyester dispersion may, for example, comprise a sulfopolyester dispersion, such as Eastek™ 1200, manufactured by Eastman Chemical Co.

Release layer 40 is preferably designed to have a viscosity of about 25 Centipoise (CPS) to 90 CPS, preferably about 50 CPS to about 60 CPS, prior to the heating and drying steps discussed below. This reduces the amount of foam created during the transfer process without the presence of a defoamer, thereby minimizing the creation of defects and dramatically improving the image rendered onto the article.

Base sheet 30 may be selected from (i) nonwoven webs, including those made from cellulosic fibers, such as coated and uncoated paper, parchment paper, and paperboard, and those made from synthetic polymers, such as polyethylene, polypropylene, polystyrene and other polyolefins; (ii) synthetic polymers sheets, including thermoplastic polymers, such as polyester (e.g. PET and PEN), poly(vinyl chloride), polystyrene, polymethacrylate, polycarbonate, polyimide, polyurethanes, ethylene-vinyl acetate, and polytetrafluoroethylene, and thermosetting resins; (iii) metalized films, including metalized biaxially-oriented polyethylene terephthalate; (iv) woven and knitted textile sheets made of natural or synthetic fibers and combinations thereof, and (V) laminates of two or more materials from the foregoing categories, including a laminate of a nonwoven webs and a thermoplastic polymer.

The base sheet may be opaque, translucent, or transparent. The thickness of the base sheet may be in the range of about 1 mil to about 10 mil, in particular, from 2 mil to about 6 mil. This thickness is desirable so that it allows sufficient heat to pass through base sheet during transfer of the image.

Print coat layer 52 includes the ink receptor and the blocking agent. The ink receptor is preferably hydrophilic and is capable of absorbing the aqueous liquid carrier component of the ink composition used to print an image on the transfer assembly. In particular, the aqueous ink composition is printed on the upper surface of the image transfer layer, and the aqueous component of the ink is absorbed through into the image transfer layer. As the aqueous liquid carrier is drawn through the image transfer layer, the blocking agent is disrupted.

Depending on the nature of the ink composition, the colorants present in the ink composition may be absorbed by the ink receptor along with the liquid carrier, or the colorant will remain concentrated on the upper surface of the transfer sheet. For example, dyes that are soluble in the aqueous liquid carrier may be readily absorbed into the image transfer layer, whereas pigments, disperse dyes and macromolecular colorants are less mobile and penetrate less deeply into the image transfer.

By way of example, suitable ink receptors may be selected from hydrophilic polymers, including poly(acrylic acid), poly(vinyl imidazole), poly(2-hydroxyethyl methacrylate), poly(vinyl pyrrolidone), poly(vinyl)poly(pyrrolidone), and polyvinyl acetate, cationic polymers and their salts. Such as polydiallyldimethylammonium chloride, polyacrylamides, and poly(epichlorohydrin-dimethylamine); hygroscopic inorganic salts, including calcium nitrate and sodium chloride; silica; Zeolites; and other hydrophilic compounds used as flocculants, coagulants, and desiccants.

The ink receptor may be present in print coat layer in an amount of about 2% to about 25% by weight, or about 5% to about 15% or about 10%. In one embodiment, the ink receptor comprises a crosslinked homopolymer of N-vinyl-2-pyrrolidone, such as Polyplasdone™ INF-10, manufactured by Ashland™)

Blocking agents useful for the transfer sheets described herein are characterized as hydrophilic, capable of forming a film, and disruptable by the application of water. The blocking agent serves a dual function it impedes or prevents the non-printed areas of the image transfer layer from transferring to an article during heat-transfer printing, and it allows the printed areas of the image transfer layer to transfer to the article. The printed areas of the transfer assembly are able to transfer to the article, because the blocking layer is disrupted in the printed areas by the application of the aqueous ink composition.

Suitable compositions for the blocking agent include water soluble polymers selected from the group consisting of poly (vinyl alcohol), poly(ethylene glycol), poly(vinyl pyrrolidone), polyacrylic acid, polyacrylamides, N-(2-hydroxypropyl) methacrylamide, Xanthan gum, pectins, dextran, carrageenan, guar gum, cellulose ethers, including hydroxypropyl methyl cellulose (HPMC), methyl cellulose (MC), hydroxyethyl cellulose (HEC), ethyl cellulose (EC), hydroxypropyl cellulose (HPC), carboxy methyl cellulose (CMC), and polyanionic cellulose (PAC), hyaluronic acid, albumin, and starch and starch derivatives.

In an exemplary embodiment, the blocking agent comprises a starch or starch derivative. The starch may be present in the print coat layer 52 in the amount of about 20% to about 50% by weight, or about 30% to about 40% or about 36%. In embodiments, the blocking agent prevents the transfer of at least 50 weight %, or 60 weight %, in particular, 75 weight %, or even 85 weight % of the non-printed areas to the article during the transfer process.

Print coat layer 52 may include materials other than the blocking agent and the ink receptor. For example, print coat layer 52 may include certain silicas, surfactants, waxes and/or thickeners. Suitable surfactants include, but are not limited to, nonionic, anionic, cationic and amphoteric surfactants, such as sodium stearate, 4-(5-dodecyl)benzenesulfonate, sodium dodecylbenzene sulfonate wetting agents, docusate (dioctyl sodium sulfosuccinate), alkyl ether phosphates, benzalkonium chloride (BAC), perfluorooctanesulfonate (PFOS), and the like. Examples of waxes include, but are not limited to, polyolefins, polyethylenes, functionalized waxes, such as amines, amides, fluorinated waxes, mixed fluorinated and amide waxes, such as esters, quaternary amines, carboxylic acids or acrylic polymer emulsion, chlorinated polyethylenes, natural or synthetic ester waxes, carnauba wax, paraffin, and the like. Such waxes can optionally be fractionated or distilled to provide specific cuts that meet certain viscosity and/or temperature criteria. Suitable thickeners include, but are not limited to, starches, gums, pectin, paragum and the like.

In an exemplary embodiment, print coat layer 52 includes silica (such as a silica gel known in the industry as Gasil® 23F, manufactured by PQ Corporation) at about 5% to about 15%, or about 10% by weight. Print coat layer 52 further includes a surfactant (such as BYK®-348) at about 2% to about 10% of about 5% by weight. Print coat layer 52 further includes a wax, such as polyethyelene/carauba wax or the like (e.g., Microspersion® 295-40, manufactured by Micropowders, Inc.), in about 20% to about 30%, or about 26% by weight. Print coat layer 52 may also include deionized water and a thickener present in about 10% to about 15%, or about 13%, by weight. The thickener may include Paragum 265, manufactured by Para-Chem Southern, Inc.

White base coat layer 54 provides increased opacity to image transfer layer 50. This increased opacity improves the ability of the rendered image to “hide” what is behind. This allows a user to read or view the front side of the image without being distracted by print images on the back side. Suitable materials for the third layer include titanium dioxide (TiO₂) the like.

In an exemplary embodiment, white base coat layer 54 comprises TiO₂ in an amount of about 20% to about 35%, or about 28% by weight. The white base coat layer 54 may further include surfactants, crosslinkers, aqueous dispersions and other materials. In an exemplary embodiment, white base coat layer 54 includes an EAA dispersion (such as Michem® Prime 74994) in about 35% to about 45%, or about 39%, by weight; a surfactant (such as BYK®-348) in about 2% to about 5%, or about 4%, by weight, a crosslinker (such as Imprafix® 2794) in about 10% to about 15%, or about 13% by weight, an ethyl acrylic in about 7% to about 13%, or about 10% by weight, and/or a styrene acrylic (such as Unibond SA240, manufactured by Unichem) in about 3% to about 8%, or about 5%, by weight. The white base coat layer 54 may also include a thickener, such as Paragum 265, manufactured by Para-Chem Southern, Inc.

Tie coat layer 56 includes the binder, which preferably comprises a material that facilitates bonding between print coat layer 52 and white base coat layer 54 with release layer 40. The binder preferably comprises a material that does not swell when it comes into contact with water, i.e., it absorbs water (>5% and <50% of its own weight). The binder is preferably hydrophobic.

The binder may be a wax, thermoplastic polymer, or pre polymer, or combinations thereof. Additional reactive compounds may be employed in the binder composition, including cross-linking agents, monomers and oligomers, which are capable of combining with themselves or other components in the binder composition. Constituents of the binder composition may be self-crosslinking or capable of bonding to functional groups present in the article being printed, to improve washfastness. The ink compositions useful for the transfer sheets described herein include a colorant and an aqueous liquid carrier. The compositions are not limited to a particular type of colorant and include, organic and inorganic pigments, dyes, or macromolecular coloring agents, such as poly(oxyalkylene) Substituted chromophores and polymers incorporating such compounds, such as polyurethanes and polyesters. By way of further example, the colorant may be selected from sublimation dyes, disperse dyes, reactive dyes, acid dyes, and basic dyes, as well as titanium dioxide, carbon black, and calcium carbonate.

In embodiments, the binder comprises a polyester or polyester-based material, preferably at least about 40% polyester or at least about 60% polyester. During the transfer, the polyester polymer chains will reach their glass transition state (Tg). This means that the chains will separate, so when the inks sublimate, these molecules can sit between the chains. After the temperature drops, the polymer chains will sit together again and the ink molecules become trapped between the chains.

In an exemplary embodiment, tie coat layer 56 comprises an EAA dispersion (such as Michem® Prime 74994) in an amount of about 45% to about 55%, or about 49% by weight. Tie coat layer 56 may include other components, such as surfactants, crosslinkers, urethanes, polyesters and the like. In one such embodiment, tie coat layer 56 comprises a urethane (such as Sancure 200025F, an aliphatic polyester urethane dispersion manufactured by Lubrizol) in an amount of about 15% to about 25%, or about 18%, by weight, a polyester (such as Eastek™ 1200) in an amount of about 15% to about 25%, or about 18%, by weight, a surfactant (such as BYK®-348) in an amount of about 2% to about 8%, or about 4%, by weight, and a crosslinker (such as Imprafix® 2794) in an amount of about 7% to about 13% or about 10% by weight. The tie coat layer 56 may also include a thickener, such as Paragum 265, manufactured by Para-Chem Southern, Inc.

Processes for manufacturing the transfer sheets described above will now be described. Release layer 40 is applied to base layer 30 and image transfer layer 50 is then applied to, or placed in contact with, release layer 40 (or vice versa: the release layer 40 may be attached to image transfer layer 50 and then placed in contact with base layer 30).

Image transfer layer 50 is then heated to a temperature of less than about 180 degrees Fahrenheit. Applicant has discovered that applying heat above 180 degrees Fahrenheit to the transfer sheet may result in white streaks, spottiness, blistering and other defects, which all contribute to a relatively poor rendering of the image. These defects are particularly noticeable on darker or black textiles. Applicant has further discovered that these defects can be substantially minimized or eliminated with a lower temperature drying profile. In certain embodiments, the transfer sheet is heated to a temperature of about 120 degrees Fahrenheit to about 180 degrees Fahrenheit, preferably about 140 degrees Fahrenheit to about 150 degrees Fahrenheit.

In an exemplary embodiment, release layer 40 is first applied to base layer 30 at a temperature less than about 180 degrees Fahrenheit, preferably about 150 degrees F. In an exemplary embodiment, the heat is applied by two different zones of an oven. The zones may, for example, have temperatures of about 160 degrees F. in Zone 1 and 185 degrees F. in Zone 2.

Tie coat layer 56 is then applied to release layer 40 at a temperature less than about 180 degrees F., preferably about 150 degrees F. In an exemplary embodiment, the heat is applied by three different zones of an oven. The zones may, for example, have temperatures of about 175 degrees F. in Zone 3, 205 degrees F. in Zone 4 and 220 degrees F. in Zone 5.

White base coat layer 54 may then be applied to tie coat layer 56 at a temperature less than about 160 degrees F., preferably about 140 degrees F. In an exemplary embodiment, the heat is applied by two different zones of an oven. The zones may, for example, have temperatures of about 130 degrees F. in Zone 1 and 150 degrees F. in Zone 2.

Finally, print coat layer 52 is applied to white base coat layer 54 at a temperature less than about 160 degrees F., preferably about 140 degrees F. In an exemplary embodiment, the heat is applied by three different zones of an oven. The zones may, for example, have temperatures of about 140 degrees F. in Zone 3, 170 degrees F. in Zone 4 and 185 degrees F. in Zone 5.

Each zone of the oven is about 20 feet long and the coater speed may be about 80 to about 120 fpm, or about 100 fpm.

Once the transfer sheet has been formed, the operator may use the transfer sheet to transfer an image to an article. In this process, the image is applied to the upper surface of image transfer layer 50 with a suitable ink composition or print coating, as discussed above. The base layer 30 is then contacted to the article 20. A minimum pressure may be applied by a press, or other suitable machine, to transfer sheet 10 to maintain contact between base layer 30 and article 20. In certain instances wherein the article is porous, such as textiles, the pressure may be selected to increase penetration of the ink composition into interstices in the article. The pressure is selected such that it does not cause the non-printed areas to transfer to the article. The operating conditions for the press may vary depending on the precise composition of the image transfer layer, the type of colorant in the ink formulation and the composition of the article being printed. Suitable pressures may range from about 1 to about 100 psi, or from about 40 to 75 psi or about 50 to 60 psi. In one embodiment, the temperature for transferring the ink composition is between about 350 to about 400 degrees Fahrenheit, or from about 365 to about 374 degrees Fahrenheit.

In certain embodiments, the heat and pressure is applied to the transfer sheet for a period of time and at a temperature such that the ink composition is not fully cured on the article, i.e., the “degree of cure” of the ink composition in the article is less than 1. In other words, the “degree of cure” of the ink composition in the article is less than 100%, preferably about 30% to about 80%, or about 40% to about 60%. Partially curing the ink composition with heat and pressure reduces defects in the printed image, thereby improving its appearance.

The “degree of cure” is defined herein to mean the degree in which the composition has cross-linked sufficiently so that it is substantially in its final form (i.e., no further cross-linking and/or no further substantial changes will occur to the composition). The degree of cure as defined here does not necessarily mean that the composition is 100% cross-linked such it has become a fully cured resin, but rather 100% of the curing that will occur before the composition does not substantially change in function or appearance.

In an exemplary embodiment, the heat and pressure may be applied to the article and the transfer sheet for a time period of about 10 to 30 seconds, or about 15 to 20 seconds, or about 18 seconds.

In certain embodiments, the article is aged over a period of time to increase the degree of cure of the ink composition, thereby increasing the vibrancy of the printed image. For example, the article may be aged for a time period of about 2 days to about 6 months, or about 1 week to about 3 months or about 1-2 months, which results in an increase in the “degree of cure” (as defined above) by about 20% to about 80%, or about 40% to about 60%. Applicant has discovered that allowing the ink composition to complete the cure process through aging (rather than immediately with heating and drying) reduces defects caused by the drying process, while still ultimately resulting in a vivid and brilliant image in the article.

At the end of the transfer time, the transfer sheet is peeled away from the article, with the printed areas of the image transfer layer remaining bound to the article and the non-printed areas of the image transfer layer remaining bound to the support layer of the transfer sheet. In embodiments, 50 weight % or less, or 40 weight % or less, in particular, 25 weight % or less, or even 15 weight % or less of the non-printed areas of the transfer assembly is transferred to the article during the transfer process.

### EXAMPLE 1

Applicant conducted testing of conventional transfer sheets and the transfer sheets discussed herein. In a first test, Applicant tested a conventional transfer sheet (Sample 1) that included a siloxane defoamer in a coating that included the image transfer layer. In this test, Applicant applied two coatings to a base layer such as the one described above: (1) a first coating that comprises a release layer such as that described above except that the layer included a siloxane defoamer and had a solids percentage of 35.9% and a viscosity of 100 CPS; and (2) a second coating that comprises a tie coat layer that contains the binder. The tie coat layer was substantially as described above except that the layer had a solids percentage of 37.8% and a viscosity of 350 CPS after adding paragum as a thickener.

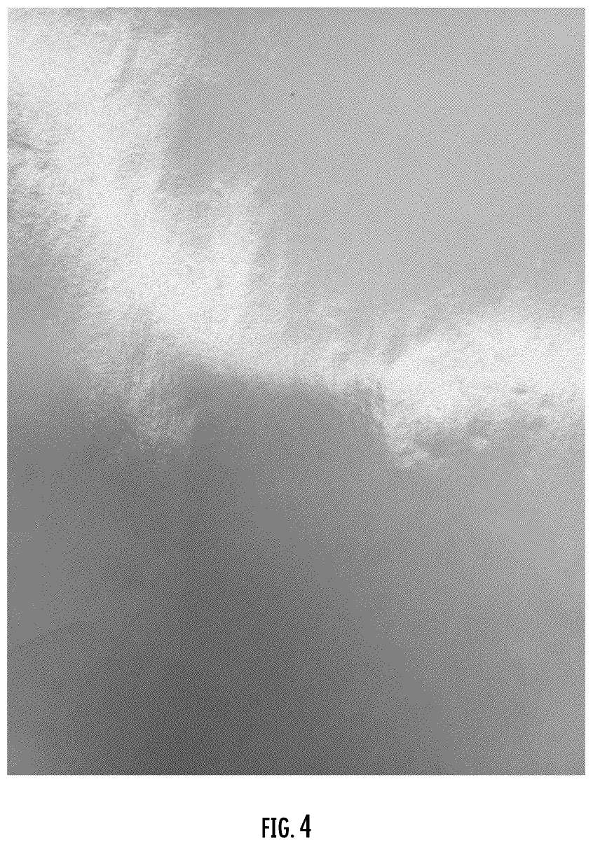

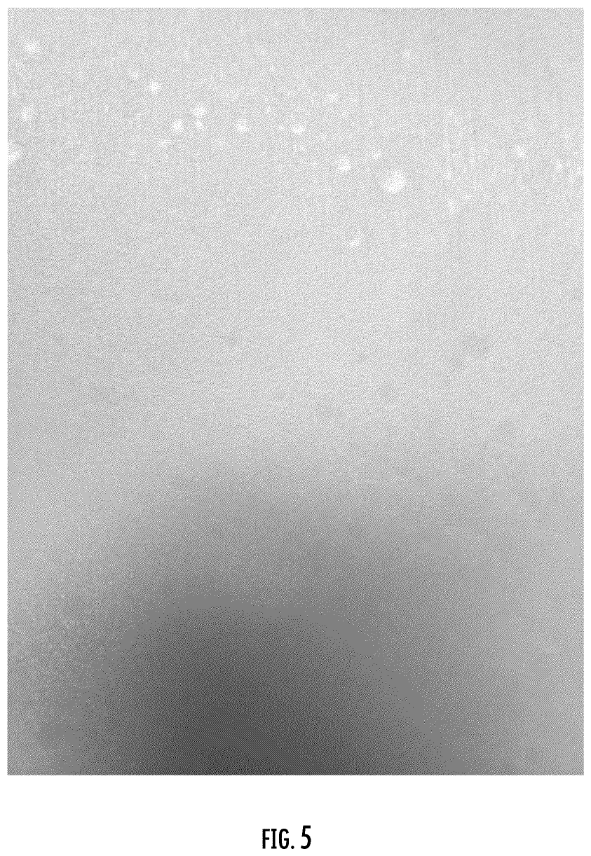

Prior to applying pressure and heating, Applicant discovered that the layers contained multiple visible fisheyes, such as circular voids or divots, in the release coating. FIG. 4 illustrates the layers after the first pass coating and FIG. 5 illustrates the layers after the second pass coating. When the second pass coating or tie coat layer was applied to the release coating, the frequency and size of the fisheyes increased.

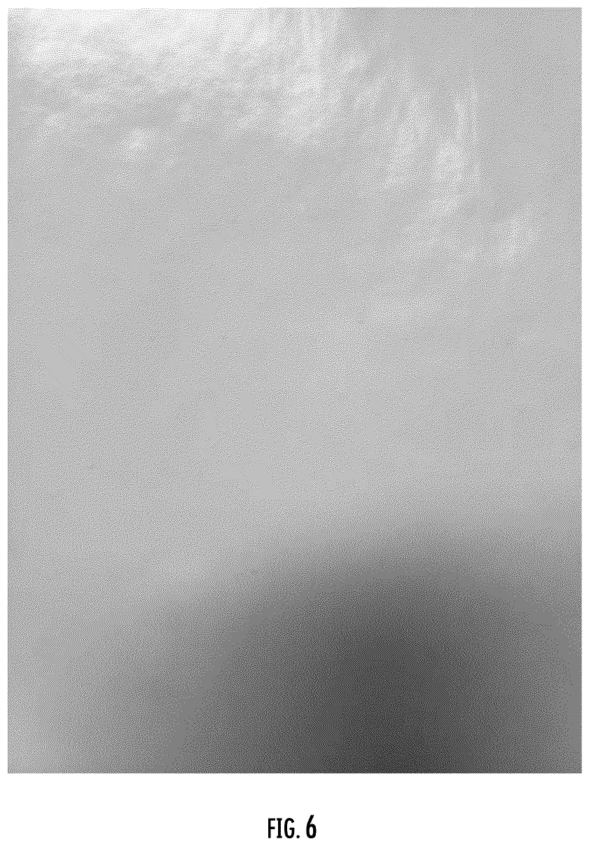

Applicant then conducted the same test under the substantially similar conditions and parameters except that the siloxane defoamer was removed from the release layer (Sample 2). Upon the conclusion of this test, it was noted that there were no fisheyes or divots in either layer and the appearance of the layers was remarkably improved (see FIG. 6).

### EXAMPLE 2

Applicant conducted a second test of Sample 2 (i.e., without the siloxane defoamer). The first pass coating or release layer contained a solids percentage of 35.2% and a viscosity of 110 CPS. The second pass coating or tie coat layer contained a solids percentage of 37.5% and a viscosity of 130 CPS after adding paragum. The two layers were coated onto the base sheet and dried in an oven with five different heating zones. The temperatures of the zones were as follows (all in degrees Fahrenheit): (1) Zone 1: 205; (2) Zone 2: 235; (3) Zone 3: 220; (4) Zone 4: 240; and (5) Zone 5: 260. The sheet temperature was 180 degrees Fahrenheit.

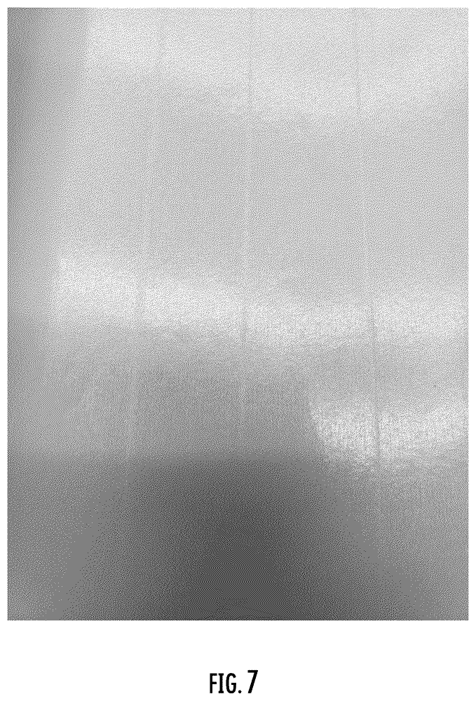

After heating and drying, it was noted that the transfer sheet contained multiple raised coating lanes, blistering and spottiness that degraded its appearance (see FIG. 7).

Applicant then applied two additional coatings to the transfer sheet in a second pass. The first coating was a white base coat layer similar to that described above and had a solids content of 43.5% and a viscosity of 120 CPS after adding paragum. The second coating was a print coat layer similar to that described above and had a solids content of 15.5% and a viscosity of 110 CPS after adding paragum. Upon application of these coatings, the entire sheet was heated and dried with a lower drying profile. The drying profile in the oven was as follows (all in degrees Fahrenheit): (1) Zone 1: 160; (2) Zone 2: 160; (3) Zone 3: 150; (4) Zone 4: 180; and (5) Zone 5: 200. The sheet temperature was 160 degrees Fahrenheit.

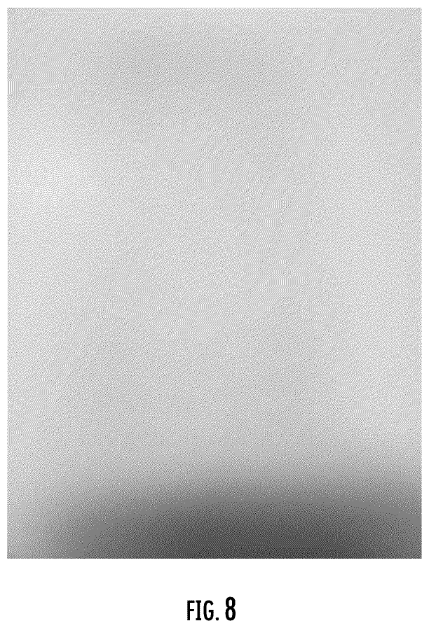

Inspection of the sheets after heating indicated that the less aggressive drying profile decreased the level of blistering and the second pass coatings covered up some of the defects of the first pass coatings (see FIG. 8). While it was noted that the transfer sheet still contained some blistering and some spottiness, it was remarkably improved in appearance after the second pass. Thus, it was concluded that a less aggressive drying profile that reduces the temperature of the transfer sheet from 180 degrees F. to 160 degrees F. improved the overall appearance of the transfer sheet.

### EXAMPLE 3

Applicant conducted a third test with the first two coatings (release layer and tie coat layer) with the following differences: (1) the release layer did not include the siloxane defoamer and had a solids percentage of 34.1% and a significantly reduced viscosity of 50 CPS; and (2) the tie coat layer had a solids percentage of 37.5% and a viscosity of 120 CPS after adding paragum. In addition, Applicant further reduced the drying profile as follow (all in degrees Fahrenheit): (1) Zone 1: 160; (2) Zone 2: 185; (3) Zone 3: 175; (4) Zone 4: 205; and (5) Zone 5: 220. The sheet temperature was 150 degrees Fahrenheit.

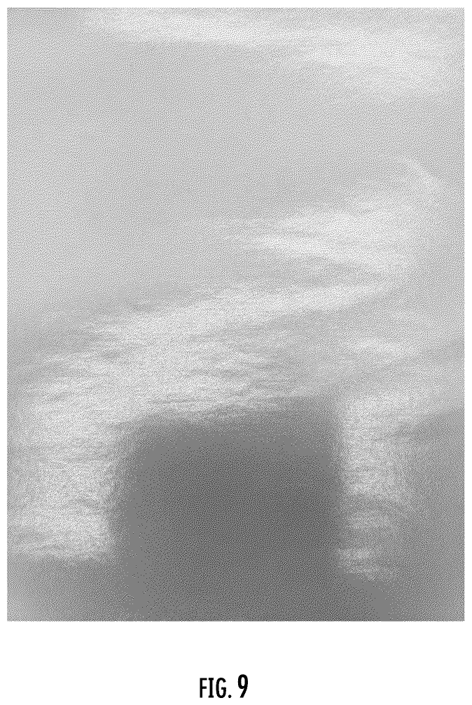

Inspections of the sheets after heating indicated that the sheet appearance from the first pass had improved significantly from the previous tests. The combination of foam, blisters, streaks and other defects was substantially eliminated from the image (see FIG. 9).

Applicant then conducted a second pass of the transfer sheet with two additional coatings: (1) a white base coat layer with a 43.5% solids and a reduced viscosity of 60 CPS after adding paragum; and (2) a print coat layer with a 15.5% solids and a viscosity of 110 CPS. Similar to the first pass, a reduced drying profile was applied (all in degrees Fahrenheit): (1) Zone 1: 130; (2) Zone 2: 150; (3) Zone 3: 143; (4) Zone 4: 170; and (5) Zone 5: 185. The sheet temperature was 140 degrees Fahrenheit.

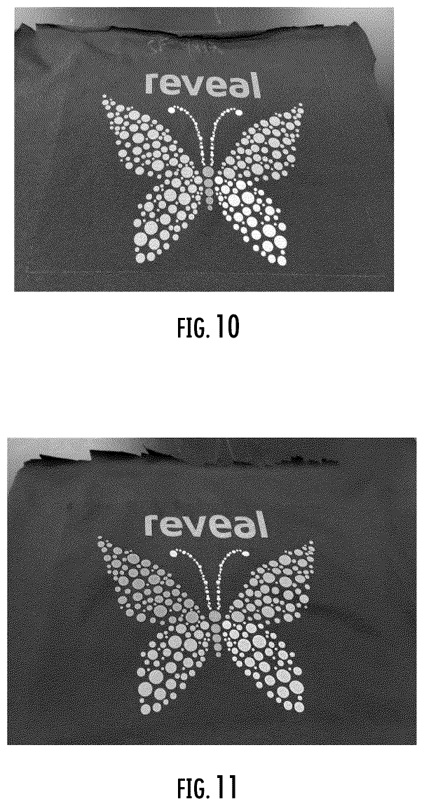

Inspection of the sheets after heating indicated that the blistering and spottiness from previous tests were not present after the second pass on the third test sample. In addition, a fresh transfer of the image to a T-shirt demonstrated good weedability (i.e., the non-printed areas did not contain any visible ink composition). The image initially had a relative low vibrancy (see FIG. 10). However, Applicant then conducted an accelerated aging test on the T-shirt, which demonstrated that this vibrancy increased dramatically with aging (see FIG. 11). The accelerated aging of the T-shirt simulated a time period of about 2 months.

While the devices, systems and methods have been described in detail herein in accordance with certain preferred embodiments thereof, many modifications and changes therein may be effected by those skilled in the art. Accordingly, the foregoing description should not be construed to be limited thereby but should be construed to include such aforementioned obvious variations and be limited only by the spirit and scope of the following claims.

For example, in a first aspect, a first embodiment is a transfer sheet for transferring an image onto a substrate. The transfer sheet is produced by a process comprising providing a support layer and an image transfer layer in contact with the support layer, the image transfer layer comprising an ink receptor and a blocking agent and applying heat and pressure to the image transfer layer such that the image transfer layer is heated to a temperature of less than about 180 degrees Fahrenheit during production.

A second embodiment is the first embodiment, wherein the image transfer layer is heated to a temperature of about 120 degrees Fahrenheit to about 180 degrees Fahrenheit during production.

A third embodiment is any combination of the first 2 embodiments, wherein the image transfer layer is heated to a temperature of about 140 degrees Fahrenheit to about 150 degrees Fahrenheit during production.

A 4^{th} embodiment is any combination of the first 3 embodiments, further comprising applying a release layer between the support layer and the image transfer layer, wherein the viscosity of the release layer is about 25 CPS to about 90 CPS.

A 5^{th} embodiment is any combination of the first 4 embodiments, wherein the viscosity of the release layer is about 50 CPS to about 60 CPS.

A 6^{th} embodiment is any combination of the first 5 embodiments, further comprising applying an ink composition onto a surface of the image transfer layer thereby defining printed areas and non-printed areas.

A 7^{th} embodiment is any combination of the first 6 embodiments, wherein the ink composition comprises a liquid carrier, wherein the blocking agent is substantially disrupted by the liquid carrier in the printed areas and the blocking agent is substantially not disrupted by the liquid carrier in the non-printed areas.

An 8^{th} embodiment is any combination of the first 7 embodiments, wherein the ink composition further comprises a colorant, wherein the colorant is affixed to the substrate in the printed areas.

A 9^{th} embodiment is any combination of the first 8 embodiments, wherein the substrate is a dark colored or black textile.

A 10^{th} embodiment is any combination of the first 9 embodiments, wherein the textile comprises cotton or cotton/polyester blends.

An 11^{th} embodiment is any combination of the first 10 embodiments, wherein the blocking agent substantially blocks the transfer of at least about 50 weight % of the ink composition to the article in the non-printed areas and substantially allows transfer of the ink composition to the article in the printed areas.

A 12^{th} embodiment is any combination of the first 11 embodiments, wherein the image transfer layer comprises a partially fluid coating having a viscosity of about 25 CPS to about 200 CPS.

A 13^{th} embodiment is any combination of the first 12 embodiments, further comprising contacting the transfer sheet with the substrate.

A 14^{th} embodiment is any combination of the first 13 embodiments, further comprising applying heat and pressure to the transfer sheet at a temperature and for a time period such that a degree of cure of the coating composition in the substrate is less than 100%.

A 15^{th} embodiment is any combination of the first 14 embodiments, wherein the degree of cure is about 30% to about 80%.

A 16^{th} embodiment is any combination of the first 15 embodiments, wherein the time period is about 15 to about 20 seconds.

A 17^{th} embodiment is any combination of the first 16 embodiments, further comprising aging the sheet to increase the degree of cure of the coating composition within the substrate.

In another aspect, a first embodiment is a transfer sheet for transferring an image onto a substrate. The transfer sheet comprises a support layer, an image transfer layer overlying the support layer and comprising an ink receptor and a blocking agent and a release layer between the support layer and the image transfer layer, wherein the viscosity of the release layer is about 25 CPS to about 90 CPS.

A second embodiment is the first embodiment, wherein the viscosity of the release layer is about 50 CPS to about 60 CPS.

A 3^{rd} embodiment is any combination of the first 2 embodiments, wherein the ink receptor is configured to receive an ink composition so as to define printed areas and non-printed areas in the image transfer layer, wherein the blocking agent is configured to substantially impede the transfer of the ink composition to the substrate in the non-printed areas and substantially allow transfer of the ink composition to the substrate in the printed areas.

A 4^{th} embodiment is any combination of the first 3 embodiments, wherein the image transfer layer comprises a partially fluid coating having a viscosity of about 25 CPS to about 200 CPS.

A 5^{th} embodiment is any combination of the first 4 embodiments, wherein the viscosity of the image transfer layer is about 100 CPS to about 130 CPS.

A 6^{th} embodiment is any combination of the first 5 embodiments, wherein the image transfer layer comprises a first layer comprising the ink receptor and the blocking agent and a second layer comprising a binder.

A 7^{th} embodiment is any combination of the first 6 embodiments, wherein the first and second layers are mixed together.

An 8^{th} embodiment is any combination of the first 7 embodiments, further comprising a third layer between the first and second layers, the third layer comprising one or more materials that increase an opacity of the image transfer layer.

A 9^{th} embodiment is any combination of the first 8 embodiments, wherein the first and third layers are mixed together.

A 10^{th} embodiment is any combination of the first 9 embodiments, wherein the substrate is a dark colored or black textile.

An 11^{th} embodiment is any combination of the first 10 embodiments, wherein the textile comprises cotton or cotton/polyester blends.

A 12^{th} embodiment is any combination of the first 11 embodiments, wherein the ink composition comprises a liquid carrier and wherein the blocking agent is substantially disrupted by the liquid carrier in the printed areas and the blocking agent is substantially not disrupted by the liquid carrier in the non-printed areas.

A 13^{th} embodiment is any combination of the first 12 embodiments, wherein the ink composition is hydrophilic.

A 14^{th} embodiment is any combination of the first 13 embodiments, wherein the blocking agent is hydrophilic.

A 15^{th} embodiment is any combination of the first 14 embodiments, wherein the blocking agent is selected from the group consisting of poly(vinyl alcohol), poly(ethylene glycol), poly(vinyl pyrrolidone), polyacrylic acid, polyacrylamides, N-(2-hydroxypropyl) methacrylamide, Xanthan gum, pectins, dextran, carrageenan, guar gum, cellulose ethers, hyaluronic acid, albumin, and starch and starch derivatives.

A 16^{th} embodiment is any combination of the first 15 embodiments, wherein the blocking agent comprises starch.

A 17^{th} embodiment is any combination of the first 16 embodiments, wherein the ink receptor is selected from the group consisting of poly(acrylic acid), poly(vinyl imidazole), poly(2-hydroxyethyl methacrylate), poly(vinyl pyrrolidone), poly(Vinyl)poly(pyrrolidone), and polyvinyl acetate, cationic polymers and their salts, hygroscopic inorganic salts, silica and zeolites.

An 18^{th} embodiment is any combination of the first 17 embodiments, wherein the binder is selected from the group consisting of a wax, a thermoplastic polymer or pre-polymer and combinations thereof.

A 19^{th} embodiment is any combination of the first 18 embodiments, wherein the binder comprises polyester or a polyester blend.

In another aspect, a first embodiment is article with a printed image produced by a process. The process comprises providing a transfer sheet comprising a support layer and an image transfer layer bonded to the support layer, the image transfer layer comprising an ink receptor and a blocking agent, applying an ink composition onto a surface of the image transfer layer thereby defining printed areas and non-printed areas, contacting the article with the transfer sheet, applying heat and pressure to the transfer sheet at a temperature and for a time period to cure the ink composition in the article such that a degree of cure of the ink composition within the article is less than 100% and separating the transfer sheet from the article.

A second embodiment is the first embodiment, wherein the degree of cure is about 30% to about 80%.

A 3rd embodiment is any combination of the first 2 embodiments, wherein the time period is about 15 to about 20 seconds

A 4^{th} embodiment is any combination of the first 3 embodiments, wherein the temperature is about 350 to about 400 degrees Fahrenheit.

A 5^{th} embodiment is any combination of the first 4 embodiments, further comprising aging the article to increase the degree of cure of the coating composition within the article.

A 6^{th} embodiment is any combination of the first 5 embodiments, wherein the blocking agent substantially blocks the transfer of at least about 50 weight % of the ink composition to the article in the non-printed areas and substantially allows transfer of the ink composition to the article in the printed areas.

A 7^{th} embodiment is any combination of the first 6 embodiments, wherein the article is a dark colored or black textile.

An 8^{th} embodiment is any combination of the first 7 embodiments, wherein the textile comprises cotton or cotton/polyester blends.

In another aspect, a first embodiment is a method for manufacturing a transfer sheet for transferring an image to an article. The method comprises providing a support layer and an image transfer layer, the image transfer layer comprising an ink receptor and a blocking agent, contacting the support layer with the image transfer layer and applying heat and pressure to the image transfer layer such that the image transfer layer is heated to a temperature of less than about 180 degrees Fahrenheit during production.

A second embodiment is the first embodiment, wherein the image transfer layer is heated to a temperature of about 120 degrees Fahrenheit to about 180 degrees Fahrenheit during production.

A 3rd embodiment is any combination of the first 2 embodiments, wherein the image transfer layer is heated to a temperature of about 140 degrees Fahrenheit to about 150 degrees Fahrenheit during production.

A 4^{th} embodiment is any combination of the first 3 embodiments, further comprising printing an ink composition onto a surface of the image transfer layer thereby defining printed areas and non-printed areas, wherein the blocking agent substantially blocks the transfer of at least about 50 weight % of the ink composition to the article in the non-printed areas and substantially allows the transfer of the ink composition to the article in the printed areas.

A 5^{th} embodiment is any combination of the first 4 embodiments, further comprising applying a release layer between the support layer and the image transfer layer, wherein a viscosity of the release layer is about 25 CPS to about 90 CPS.

What is claimed is:

1. A transfer sheet for transferring an image onto a substrate produced by a process comprising:
providing a support layer and an image transfer layer in contact with the support layer, the image transfer layer comprising an ink receptor and a blocking agent; and
applying heat and pressure to the image transfer layer such that the image transfer layer is heated to a temperature of less than about 180 degrees Fahrenheit during production.

2. The transfer sheet of claim 1, wherein the image transfer layer is heated to a temperature of about 120 degrees Fahrenheit to about 180 degrees Fahrenheit during production.

3. The transfer sheet of claim 1, wherein the image transfer layer is heated to a temperature of about 140 degrees Fahrenheit to about 150 degrees Fahrenheit during production.

4. The transfer sheet of claim 1, further comprising applying a release layer between the support layer and the image transfer layer, wherein the viscosity of the release layer is about 25 CPS to about 90 CPS.

5. The transfer sheet of claim 4, wherein the viscosity of the release layer is about 50 CPS to about 60 CPS.

6. The transfer sheet of claim 1, further comprising applying an ink composition onto a surface of the image transfer layer thereby defining printed areas and non-printed areas, wherein the ink composition comprises a liquid carrier, wherein the blocking agent is substantially disrupted by the liquid carrier in the printed areas and the blocking agent is substantially not disrupted by the liquid carrier in the non-printed areas.

7. The transfer sheet of claim 1, wherein the substrate is a dark colored or black textile.

8. The transfer sheet of claim 1, wherein the image transfer layer comprises a partially fluid coating having a viscosity of about 25 CPS to about 200 CPS.

9. The transfer sheet of claim 1, further comprising contacting the transfer sheet with the substrate and applying heat and pressure to the transfer sheet at a temperature and for a time period such that a degree of cure of the coating composition in the substrate is less than 100%.

10. The transfer sheet of claim 9, wherein the degree of cure is about 30% to about 80%.

11. The transfer sheet of claim 9, wherein the time period is about 15 to about 20 seconds.

12. The transfer sheet of claim 9, further comprising aging the sheet to increase the degree of cure of the coating composition within the substrate.

13. A transfer sheet for transferring an image onto a substrate, the transfer sheet comprising:
a support layer;
an image transfer layer overlying the support layer and comprising an ink receptor and a blocking agent; and
a release layer between the support layer and the image transfer layer, wherein the viscosity of the release layer is about 25 CPS to about 90 CPS.

14. The transfer sheet of claim 13, wherein the viscosity of the release layer is about 50 CPS to about 60 CPS.

15. The transfer sheet of claim 13, wherein the ink receptor is configured to receive an ink composition so as to define printed areas and non-printed areas in the image transfer layer, wherein the blocking agent is configured to substantially impede the transfer of the ink composition to the substrate in the non-printed areas and substantially allow transfer of the ink composition to the substrate in the printed areas.

16. The transfer sheet of claim 13, wherein the image transfer layer comprises a partially fluid coating having a viscosity of about 25 CPS to about 200 CPS.

17. The transfer sheet of claim 16, wherein the viscosity of the image transfer layer is about 100 CPS to about 130 CPS.

18. The transfer sheet of claim 13, wherein the image transfer layer comprises a first layer comprising the ink receptor and the blocking agent and a second layer comprising a binder.

19. The transfer sheet of claim 18, wherein the first and second layers are mixed together.

20. The transfer sheet of claim 18, further comprising a third layer between the first and second layers, the third layer comprising one or more materials that increase an opacity of the image transfer layer, wherein the first and third layers are mixed together.

21. The transfer sheet of claim 13, wherein the substrate is a dark colored or black textile and the textile comprises cotton or cotton/polyester blends.

22. The transfer sheet of claim 13, wherein the ink composition comprises a liquid carrier, wherein the blocking agent is substantially disrupted by the liquid carrier in the printed areas and the blocking agent is substantially not disrupted by the liquid carrier in the non-printed areas.
